(19) United States
(12) Patent Application Publication
(10) Pub. No.: US 2019/0111357 A1
(43) Pub. Date: Apr. 18, 2019

(54) DATA LINE FOR TOY BRICK

(71) Applicant: Shenzhen Dayoda Technology Co., ltd, Shenzhen (CN)

(72) Inventor: David WANG, Shenzhen (CN)

(21) Appl. No.: 15/795,279

(22) Filed: Oct. 27, 2017

(30) Foreign Application Priority Data
Oct. 17, 2017 (CN) 201710962466.3

(51) Int. Cl. A63H 33/04; H01R 25/00; A63H 33/08

(52) U.S. Cl. CPC A63H 33/042; A63H 33/088; H01R 25/003

(57) ABSTRACT

A data line for a toy brick includes a connecting portion for the toy brick, a first connecting portion and a second connecting portion. The connecting portion for the toy brick is a modular combination structure and includes a first connection end and a second connection end electrically connected to the first connection end. Use first connecting portion includes a third connection end and a first device connection end electrically connected to the third connection end. The second connecting portion includes a fourth connection end and a first device connection end electrically connected to the fourth connection end. The first and second device connection ends respectively connect to a first device and a second device. The data line for the toy brick still can be connected to a data line to improve the enjoyment of the data line for the toy brick after any combination of the toy bricks.

### BACKGROUND

### 1. Technical Field

The present disclosure generally relates to data lines field, and especially relates to a data line for a toy brick.

### 2. Description of Related Art

A data lines is an essential supporting part of an electrical device. A toy brick is a kind of toy equipment with more interesting, which can be used in the work to relieve stress and relax body and mind. However, a conventional combination of a data line with a toy brick can't obtain an effective combination of an interest of the toy brick and an electro-conductivity of the data line.

### SUMMARY

The disclosure relates to a data line for a toy brick which still can be connected to a data line to improve the enjoyment of the data line for the toy brick after any combination of the toy bricks.

The object of the present disclosure is to achieve by the following technical proposal:

In one aspect, a data line for a toy brick configured for signal transmission between a first device and a second device, the data line for the toy brick includes a connecting portion for the toy brick, a first connecting portion and a second connecting portion electrically connected to the first connecting portion. The connecting portion for the toy brick is a modular combination structure and includes a first connection end and a second connection end electrically connected to the first connection end. The first connecting portion includes a first device connection end and a third connection end electrically connected to the first device connection end. The second connecting portion includes a fourth connection end and a second device connection end electrically connected to the fourth connection end. The first device connection end is electrically connected to the first device, and the second device connection end is electrically connected to the second device; while the first connection end is electrically connected to the third connection end, and the second connection end is electrically connected to the fourth connection end. Or, the third connection end is electrically connected to the fourth connection end. The connecting portion for the toy brick is as a kind of toy bricks.

Wherein the connecting portion for the toy brick includes an elbow connecting portion, a cross connecting portion, a T-shaped connecting portion and a linear connecting portion. The elbow connecting portion includes: a first elbow connection end and a second elbow connection end electrically connected to the first elbow connection end, an angle formed at the connection between the first elbow connection end and the second elbow connection end. The cross connecting portion includes a first cross connection end, a second cross connection end, a third cross connection end and a fourth cross connection end. The first cross connection end is electrically connected to each of the second cross connection end, the third cross connection end and the fourth cross connection end, the second cross connection end is electrically connected to both of the third cross connection end and the fourth cross connection end, and the third cross connection end is electrically connected to the fourth cross connection end. The first cross connection end and the third cross connection end are on a first line, and the second cross connection end and the fourth cross connection end are on a second line, with the first line perpendicular to the second line. The T-shaped connecting portion includes a first T-shaped connection end, a second T-shaped connection end and a third T-shaped connection end. The first T-shaped connection end is electrically connected to the second T-shaped connection end and the third T-shaped connection end, and the second T-shaped connection end is electrically connected to the third T-shaped connection end. The first T-shaped connection end and the second T-shaped connection end are on a third line which is perpendicular to the third T-shaped connection end. The linear connecting portion includes a first linear connection end and a second linear connection end electrically connected to the first linear connection end. The first elbow connection end is electrically connected to the first cross connection end, the second cross connection end is electrically connected to the first T-shaped connection end, and the second T-shaped connection end is electrically connected to the first linear connection end. Two connection ends selected from the second elbow connection end, the third cross connection end, the fourth cross connection end, the third T-shaped connection end and the second linear connection end are respectively connected to the third connection end and the fourth connection end.

Wherein the connecting portion for the toy brick includes four elbow connecting portions, two cross connecting portions, two T-shaped connecting portions and eight linear connecting portions.

Wherein the four elbow connecting portions, the two cross connecting portions, the two T-shaped connecting portions and the eight linear connecting portions are assembled and then simultaneously connected to the third connection end and the fourth connection end.

Wherein the connecting portion for the toy brick farther includes a Y-shaped connecting portion which includes a first Y-shaped connection end, a second Y-shaped connection end and a third Y-shaped connection end. The first Y-shaped connection end is electrically connected to both the second Y-shaped connection end and the third Y-shaped connection end, and the second Y-shaped connection end is electrically connected to the third Y-shaped connection end. The first Y-shaped connection end and/or the second Y-shaped connection end and/or the third Y-shaped connection end are connected to the second elbow connection end, and two connection ends selected from the third cross connection end, the fourth cross connection end, the third T-shaped connection end and the second linear connection end are respectively connected to the third connection end and the fourth connection end.

Wherein the connecting portion for the toy brick includes thirteen elbow connecting portions, seven cross connecting portions, seven T-shaped connecting portions, sixteen linear connecting portions and three Y-shaped connecting portions.

Wherein the connecting portion for the toy brick further includes a multiple branch connecting portion which includes a first branch connecting portion, a second branch connecting portion, a third branch connecting portion, a fourth branch connecting portion, a fifth branch connecting portion and a sixth branch connecting portion. The first branch connecting portion, the second branch connecting portion, the third branch connecting portion, the fourth branch connecting portion, the fifth branch connecting portion and the sixth branch connecting portion are electrically connected to each other. The first branch connecting portion and the fourth branch connecting portion are on a same line, the second branch connecting portion and the fifth branch connecting portion are on another same line, and the third branch connecting portion and the sixth branch connecting portion are on a third same line.

Wherein the first branch connecting portion, the second branch connecting portion, the third branch connecting portion, the fourth branch connecting portion, the fifth branch connecting portion and the sixth branch connecting portion are evenly located along the center of a same plane, while a first center connecting portion is arranged on the center of the same plane and respectively electrical connection to each of the first branch connecting portion, the second branch connecting portion, the third branch connecting portion, the fourth branch connecting portion, the fifth branch connecting portion and the sixth branch connecting portion.

Wherein the connecting portion for the toy brick further includes a U-shaped connecting portion which includes a first U-shaped connection end and a second U-shaped connection end electrically connected to the first U-shaped connection end.

Wherein the elbow connecting portion, the cross connecting portion, the T-shaped connecting portion and the linear connecting portion are arranged into plug connections, and the plug can be selected from a DC plug, an audio threaded plug, an audio un-threaded plug, a magnetic suction plug, a Micro 5 pin plug, a TYPE-C plug, a Lighting plug and a USB plug.

In another aspect, a data line for the toy brick for signal transmission between a first device and a second device includes a connecting portion for the toy brick, a first connecting portion, a second connecting portion, an elbow connecting portion, a cross connecting portion, a T-shaped connecting portion and a linear connecting portion. The connecting portion for the toy brick is a modular combination structure and includes a first connection end and a second connection end electrically connected to the first connection end. The first connecting portion includes a first device connection end and a third connection end electrically connected to the first device connection end. The second connecting portion includes a fourth connection end and a second device connection end electrically connected to the fourth connection end. The elbow connecting portion is electrically connected to one end of the cross connecting portion, the T-shaped connecting portion is electrically connected to another end of the cross connecting portion, and the linear connecting portion is electrically connected to another end of the T-shaped connecting portion. The first device connection end is electrically connected to the first device, and the second device connection end is electrically connected to the second device; while the first connection end is electrically connected to the third connection end, and the second connection end is electrically connected to the fourth connection end. Or, the third connection end is electrically connected to the fourth connection end. The connecting portion for the toy brick is as a kind of toy bricks.

Wherein the elbow connecting portion for the toy brick includes a first elbow connection end and a second elbow connection end electrically connected to the first elbow connection end, and an angle formed at the connection between the first elbow connection end and the second elbow connection end. The cross connecting portion includes a first cross connection end, a second cross connection end, a third cross connection end and a fourth cross connection end. The first cross connection end is electrically connected to each of the second cross connection end, the third cross connection end and the fourth cross connection end, the second cross connection end is electrically connected to both the third cross connection end and the fourth cross connection end, and the third cross connection end is electrically connected to the fourth cross connection end. The first cross connection end and the third cross connection end is on a first line, and the second cross connection end and the fourth cross connection end is on a second line, with the first line perpendicular to the second line. The T-shaped connecting portion includes a first T-shaped connection end, a second T-shaped connection end and a third T-shaped connection end. The first T-shaped connection end is electrically connected to the second T-shaped connection end and the third T-shaped connection end, and the second T-shaped connection end is electrically connected to the third T-shaped connection end. The first T-shaped connection end and the second T-shaped connection end is on a third line which is perpendicular to the third T-shaped connection end. The linear connecting portion includes a first linear connection end and a second linear connection end electrically connected to the fast linear connection end. The first elbow connection end is electrically connected to the first cross connection end, the second cross connection end is electrically connected to the first T-shaped connection end, the second T-shaped connection end is electrically connected to the first linear connection end. Two connection ends selected from the second elbow connection end, the third cross connection end, the fourth cross connection end, the third T-shaped connection end and the second linear connection end are respectively connected to the third connection end and the fourth connection end.

Wherein the connecting portion for the toy brick includes four elbow connecting portions, two cross connecting portions, two T-shaped connecting portions and eight linear connecting portions. The four elbow connecting portions, the two cross connecting portions, the two T-shaped connecting portions and the eight linear connecting portions are assembled and then simultaneously connected to the third connection end and the fourth connection end.

Wherein the elbow connecting portion, the cross connecting portion, the T-shaped connecting portion and the linear connecting portion are arranged into plug connections, and the plug can be selected from a DC plug, an audio threaded plug, an audio un-threaded plug, a magnetic suction plug, a Micro 5 pin plug, a TYPE-C plug, a Lighting plug and a USB plug.

Wherein the connecting portion for the toy brick further includes a Y-shaped connecting portion which includes a first Y-shaped connection end, a second Y-shaped connection end and a third Y-shaped connection end. The first Y-shaped connection end is electrically connected to both the second Y-shaped connection end and the third Y-shaped connection end, and the second Y-shaped connection end is electrically connected to the third Y-shaped connection end. The first Y-shaped connection end and/or the second Y-shaped connection end and/or the third Y-shaped connection end are connected to the second elbow connection end, and too connection ends selected from the third cross connection end, the fourth cross connection end, the third T-shaped connection end and the second linear connection end are respectively connected to the third connection end and the fourth connection end.

Wherein the connecting portion for the toy brick includes thirteen elbow connecting portions, seven cross connecting portions, seven T-shaped connecting portions, sixteen linear connecting portions and three Y-shaped connecting portions.

Wherein the connecting portion for the toy brick further includes a multiple branch connecting portion which includes a first branch connecting portion, a second branch connecting portion, a third branch connecting portion, a fourth branch connecting portion, a fifth branch connecting portion and a sixth branch connecting portion. The first branch connecting portion, the second branch connecting portion, the third branch connecting portion, the fourth branch connecting portion, the fifth branch connecting portion and the sixth branch connecting portion are electrically connected to each other. The first branch connecting portion and the fourth branch connecting portion are on a same line, the second branch connecting portion and the fifth branch connecting portion are on another same line, and the third branch connecting portion and the sixth branch connecting portion are on a third same line. The first branch connecting portion, the second branch connecting portion, the third branch connecting portion, the fourth branch connecting portion, the fifth branch connecting portion and the sixth branch connecting portion are evenly located along the center of a same plane, while a first center connecting portion is arranged on the center of the same plane and respectively electrical connection to each of the first branch connecting portion, the second branch connecting portion, the third branch connecting portion, the fourth branch connecting portion, the fifth branch connecting portion and the sixth branch connecting portion.

Wherein the connecting portion for the toy brick further includes a U-shaped connecting portion which includes a first U-shaped connection end and a second U-shaped connection end electrically connected to the first U-shaped connection end.

The present disclosure provides the advantages as below.

After any combination of the connecting portion for the toy brick, it still can be connected to a data line to form a data line for the toy brick, thereby improve the enjoyment of the data line for the toy brick.

### BRIEF DESCRIPTION OF THE DRAWINGS

FIG. 1 is a schematic view of the data line for the toy brick in accordance with an exemplary embodiment.

FIG. 2 is an exploded schematic view of the data line for the toy brick of FIG. 1.

FIG. 3 is a schematic view of an elbow connecting portion of the data line for the toy brick of FIG. 2.

FIG. 4 is a schematic view of a cross connecting portion of the data line for the toy brick of FIG. 2.

FIG. 5 is a schematic view of a T-shaped connecting portion of the data line for the toy brick of FIG. 2.

FIG. 6 is another schematic view of a T-shaped connecting portion of the data line for the toy brick of FIG. 2.

FIG. 7 is a schematic view of a linear connecting portion of the data line for the toy brick of FIG. 2.

FIG. 8 is a schematic view of a Y-shaped connecting portion of the data line for the toy brick of FIG. 2.

FIG. 9 is a schematic view of a multiple branch connecting portion of the data line for the toy brick of FIG. 2.

FIG. 10 is a schematic view of a U-shaped connecting portion of the data line for the toy brick of FIG. 2.

FIG. 11 is a schematic view of a general type connection ends of the connecting portion for the toy brick of FIG. 2, which can be selected.

### DETAILED DESCRIPTION

The disclosure is illustrated by way of example and not by way of limitation in the figures of the accompanying drawings, in which like reference numerals indicate similar elements.

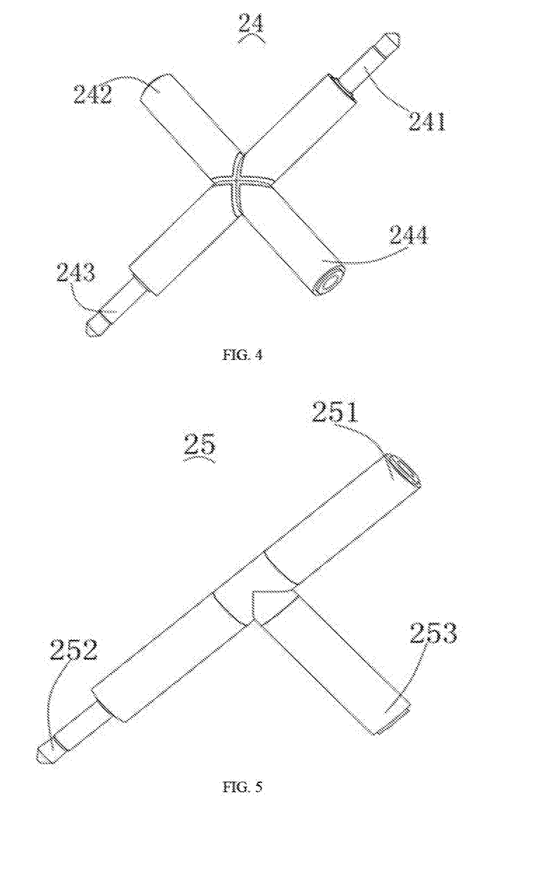

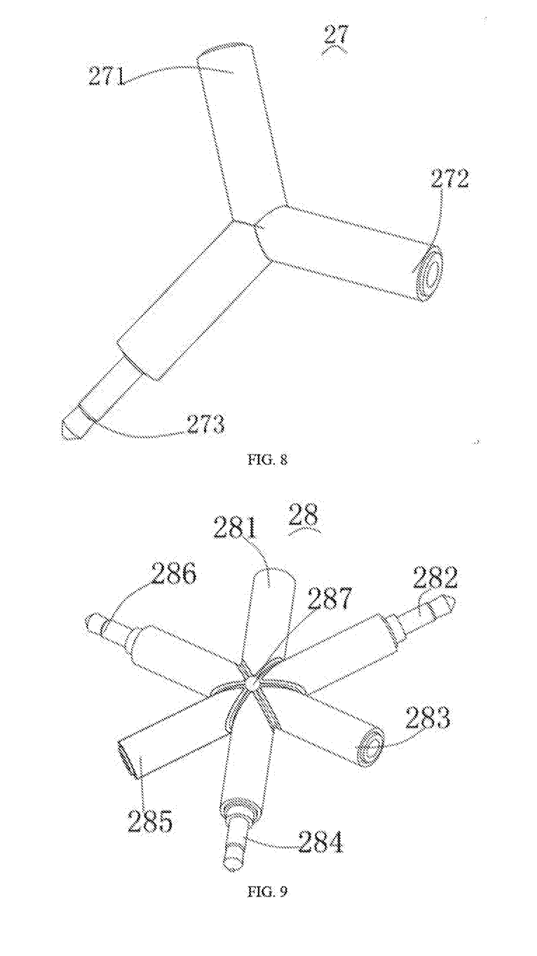

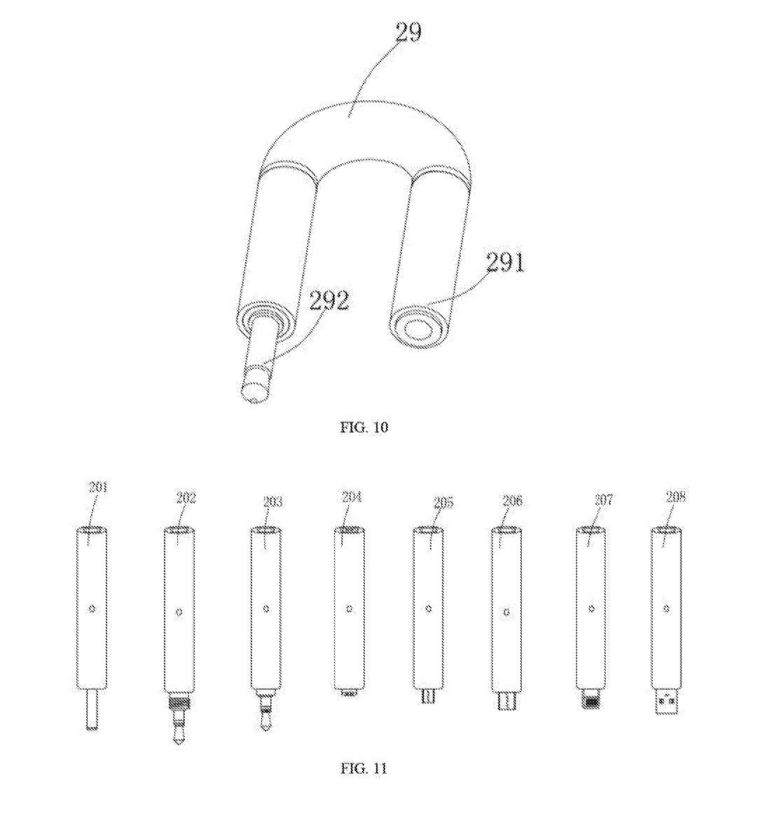

Referring to FIGS. 1-11, a data line for the toy brick 100 is configured for signal transmission between a first device (not shown) and a second device (not shown). The data line for the toy brick 100 includes a connecting portion for the toy brick 20, a first connecting portion 30 and a second connecting portion 40. In the exemplary embodiment of the present disclosure, the connecting portion for the toy brick 20 is electrically connected between the first connecting portion 30 and the second connecting portion 40.

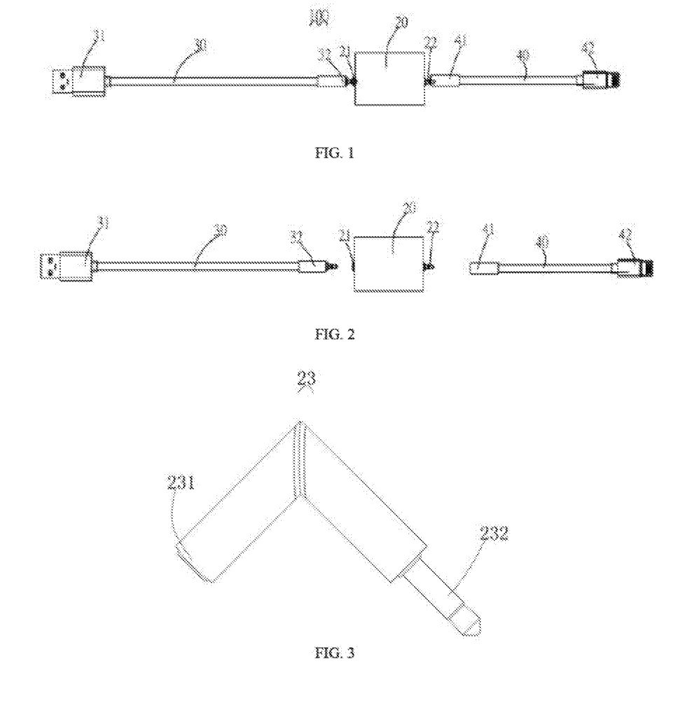

Referring to FIG. 1 and FIG. 2, the connecting portion for the toy brick 20 is a modular combination structure and includes a first connection end 21 and a second connection end 22 electrically connected to the first connection end 21. That is to say, the shape of the connecting portion for the toy brick 20 can be changed according to user's requirement, but all changes need to retain the first connecting portion 30 and the second connecting portion 40 so that the connecting portion for the toy brick 20 can be connected to the first and second connecting portions 30, 40 to form a complete data line. The shape changement of the connecting portion for the toy brick 20 not only can enhance the enjoyment of the data line for the toy brick 100, but also can enhance the consumer's attraction of the data line for the toy brick 108, which is convenient to spread and use the data line for the toy brick 100.

The first connecting portion 30 includes a first device connection end 31 and a third connection end 32 electrically connected to the first device connection end 31. The second connecting portion 40 includes a fourth connection end 41 and a second device connection end 42 electrically connected to the fourth connection end 41. The first device connection end 31 is electrically connected to the first device, and the second device connection end 42 is electrically connected to the second device. The first connection end 21 is electrically connected to the third connection end 32, and the second connection end 22 is electrically connected to the fourth connection end 41. Or, the third connection end 32 is electrically connected to the fourth connection end 41. In the exemplary embodiment of the present disclosure, the connecting portion for the toy brick 20 is as a kind of toy bricks. The connecting portion for the toy kick 20 can be used for combining toy bricks, and the combination structure can be electrically connected to the first connecting portion 30 and the second connecting portion 40, thus enhancing the interest of the data line for the toy brick 100.

Referring to FIGS. 1-7 and FIG. 11, the connecting portion for the toy brick 20 includes an elbow connecting portion 23, a cross connecting portion 24, a T-shaped connecting portion 25 and a linear connecting portion 26. The elbow connecting portion 23 is electrically connected to one end of the cross connecting portion 24, the T-shaped connecting portion 25 is electrically connected to another end of the cross connecting portion 24, and the linear connecting portion 26 is electrically connected to another end of the T-shaped connecting portion 25.

The elbow connecting portion 23 includes a first elbow connection end 231 and a second elbow connection end 232 electrically connected to the first elbow connection end 231. An angle is formed at the connection between the first elbow connection end 231 and the second elbow connection end 232.

The cross connecting portion 24 includes a first cross connection end 241, a second cross connection end 242, a third cross connection end 243 and a fourth cross connection end 244. The first cross connection end 241 is electrically connected to each of the second cross connection end 242, the third cross connection end 243 and the fourth cross connection end 244. The second cross connection end 242 is electrically connected to both the third cross connection end 243 and the fourth cross connection end 244, and the third cross connection end 243 is electrically connected to the fourth cross connection end 244. The first cross connection end 241 and the third cross connection end 243 are on a first line, and the second cross connection end 242 and the fourth cross connection end 244 are on a second line, with the first line perpendicular to the second line.

The T-shaped connecting portion 25 includes a first T-shaped connection end 251, a second T-shaped connection end 252 and a third T-shaped connection end 253. The first T-shaped connection end 251 is electrically connected to both the second T-shaped connection end 252 and the third T-shaped connection end 253, and the second T-shaped connection end 252 is electrically connected to the third T-shaped connection end 253. The first T-shaped connection end 251 and the second T-shaped connection end 252 are on a third line which is perpendicular to the third T-shaped connection end 253.

The linear connecting portion 26 includes a first linear connection end 261 and a second linear connection end 262 electrically connected to the first linear connection end 261. The first elbow connection end 231 is electrically connected to the first cross connection end 241, the second cross connection end 242 is electrically connected to the first T-shaped connection end 251, and the second T-shaped connection end 252 is electrically connected to the first linear connection end 261. Two connection ends selected from the second elbow connection end 232, the third cross connection end 243, the fourth cross connection end 244, the third T-shaped connection end 253 and the second linear connection end 262 are respectively connected to the third connection end 32 and the fourth connection end 41, thereby a complete data line for the toy brick is obtained.

The electrical signals (signal transmission and/or charging) of the data line for the toy brick 100 all pass therethrough, thereby combining the conventional cable function with the interesting function of the toy brick together so that the data line for the toy brick 100 also has the interesting function of the toy brick with shape-shifting combination under not affecting the function as the data line. The above connection ends (for easy to understand, call the elements: the third connection end 32, the fourth connection end 41, the first elbow connection end 231, the second elbow connection end 232, the first cross connection end 241, the second cross connection end 242, the third cross connection end 243, the fourth cross connection end 244, the first T-shaped connection end 251. The second T-shaped connection end 252, the third T-shaped connection end 253, the first linear connection end 261 and the second linear connection end 262, as a connection end) can be setup as a magnetic suction joint to satisfy the conductive function. At the same time, any two connection ends mentioned above, the combination of any two connection ends is stable and reliable, which has the advantages of conveniently use and many kinds of deformation of the connecting portion for the toy brick 20. Of course, the connection ends mentioned above also can be set up as a plug/socket. The elbow connecting portion 23, the cross connecting portion 24, the T-shaped connecting portion 25 and the linear connecting portion 26 can be arranged into plug connections, the engagement of the plug and the socket can be selected front a DC plug 201, an audio threaded plug 202, an audio un-threaded plug 203, a magnetic suction plug 204, a Micro 5 pin plug 205, a TYPE-C plug 206, a lighting plug 207 and a USB plug 208. Of course, the type of the plug selected should be connected to a corresponding socket. In this way, by the connection of the plug and the socket, it is easy to electrically connect to the two connection ends and simultaneously removable connection of the two connection ends to ensure forming a stable and reliable structure of the specific connecting portion for the toy brick 20 after assembly.

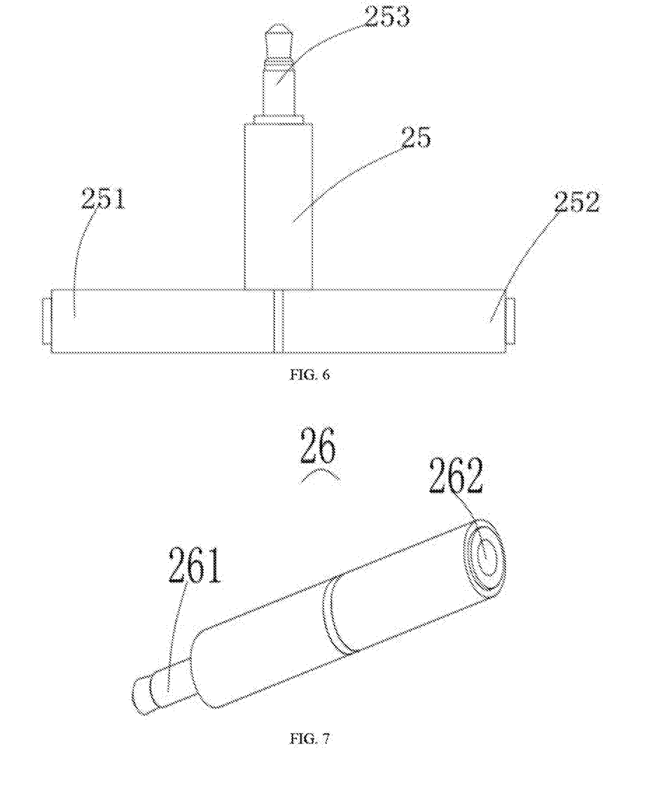

Referring to FIG. 5 and FIG. 6, the first T-shaped connection end 251 is a socket, both the second T-shaped connection end 252 and the third T-shaped connection end 253 are plugs shown in FIG. 5, while both the first T-shaped connection end 251 and the second T-shaped connection end 252 are sockets, and the third T-shaped connection end 253 is a plug shown in FIG. 6. The T-shaped connecting portion 25 includes but not limited to the two types of socket and plug arrangement mentioned above. The connecting portion for the toy brick 20 can include one or more of the various types of plug and socket arrangement of the T-shaped connecting portion 25, not limited it here.

Referring to FIGS. 1-7, in the exemplary embodiment of the present disclosure, there are four elbow connecting portions 23, two cross connecting portions 24, two T-shaped connecting portions 25 and eight linear connecting portions 26. This quantity mentioned above is a basic toy brick unit, which can satisfy the deformation of the connecting portion for the toy brick 26 by reference of the conventional combination of blocks. Any two unconnected connection ends meet the electrical connection requirements after the deformed assembly of the connecting portion for the toy brick 20 (for easy to understand call the elements: the third connection end 32, the fourth connection end 41, the first elbow connection end 231, the second elbow connection end 232, the first cross connection end 241, the second cross connection end 242, the third cross connection end 243, the fourth cross connection end 244, the first T-shaped connection end 251, the second T-shaped connection end 252, the third T-shaped connection end 253, the first linear connection end 261 and the second linear connection end 262, as a connection end). In this way, the unconnected connection ends mentioned above can meet the demand of electrical connection alter the combination deformation of the toy brick, and the combination structure can be electrically connected to the first connecting portion 30 and the second connecting portion 40, thus enhancing the interest of the data line for the toy brick 100. Of course, the user can select a plurality of toy brick units from the four elbow connecting portions 23, the two cross connecting portions 24, the two T-shaped connecting portions 25 and the eight linear connecting portions 26 (for easy to understand, the elements: the elbow connecting portion 23, the cross connecting portion 24, the T-shaped connecting portion 25 and the linear connecting portion 26, collectively referred to as a toy brick unit) to assembly (for example: selected one elbow connecting portion 23, one cross connecting portion 24, one T-shaped connecting portion 25 and one linear connecting portion 26). The unselected toy brick unit (for example: three elbow connecting portions 23, one cross connecting portion 24, one T-shaped connecting portion 25 and seven linear connecting portions 26) can not affect the use function of the connecting portion for the toy brick 20 as the data line, whether they are connected or not connected to the first connecting portion 30 and the second connecting portion 40. In addition, it can increase the length of the data line for the toy brick 100 when the unselected toy brick units (for example: three elbow connecting portions 23, one cross connecting portion 24, one T-shaped connecting portion 25 and seven linear connecting portions 26) are electrically connected to the first connecting portion 30 and the second connecting portion 40.

Referring to FIGS. 1-7, the four elbow connecting portions 23, the two cross connecting portions 24, the two T-shaped connecting portions 25 and the eight linear connecting portions 26 are assembled and then simultaneously connected to the third connection end 32 and the fourth connection end 41, thereby realizing the function as the data line.

Referring to FIGS. 1-8, the connecting portion for the toy brick 20 further includes a Y-shaped connecting portion 27. The Y-shaped connecting portion 27 includes a first Y-shaped connection end 271, a second Y-shaped connection end 272 and a third Y-shaped connection end 273 electrically connected to each other. The first Y-shaped connection end 271 is electrically connected to both the second Y-shaped connection end 272 and the third Y-shaped connection end 273, and the second Y-shaped connection end 272 is electrically connected to the third Y-shaped connection end 273. The first Y-shaped connection end 271 and/or the second Y-shaped connection end 272 and/or the third Y-shaped connection end 273 are connected to the second elbow connection end 232, and two connection ends selected from the third cross connection end 243, the fourth cross connection end 244, the third T-shaped connection end 253 and the second linear connection end 262 are respectively connected to the third connection end 32 and the fourth connection end 41. The Y-shaped connecting portion 27 can increase the variety of the connecting portion for the toy brick 20, thus enabling consumers can combine more shapes of the toy bricks.

Referring to FIGS. 1-8, in the exemplary embodiment, of the present disclosure, the connecting portion for the toy brick 20 includes thirteen elbow connecting portions 23, seven crass connecting portions 24, seven T-shaped connecting portions 25, sixteen linear connecting portions 26 and three Y-shaped connecting portions 27. As a basic unit of a combination toy brick, the connecting portion for the toy brick 20 can meet consumer's demand and enhance the fun of the data line for the toy brick 100.

Referring to FIGS. 1-9, the connecting portion for the toy brick 20 further includes a multiple branch connecting portion 28. The multiple branch connecting portion 28 includes a first branch connecting portion 281, a second branch connecting portion 282, a third branch connecting portion 283, a fourth branch connecting portion 284, a fifth branch connecting portion 285 and a sixth branch connecting portion 286. The first branch connecting portion 281, the second branch connecting portion 282, the third branch connecting portion 283, the fourth branch connecting portion 284, the fifth branch connecting portion 285 and the sixth branch connecting portion 286 are electrically connected to each other. In the exemplary embodiment of the present disclosure, the first branch connecting portion 281 and the fourth branch connecting portion 284 are on a same line, the second branch connecting portion 282 and the fifth branch connecting portion 285 are on another same line, and the third branch connecting portion 283 and the sixth branch connecting portion 286 are on a third same line. The variety of toy brick units is increased so that consumers can combine more shapes of the toy bricks to enhance the fun of the data line for toy brick 100.

Referring to FIGS. 1-9, the first branch connecting portion 281, the second branch connecting portion 282, the third branch connecting portion 283, the fourth branch connecting portion 284, the fifth branch connecting portion 285 and the sixth branch connecting portion 286 are evenly located along the center of a same plane. In this way, a first center connecting portion 287 is arranged on the center of the same plane. The multiple branch connecting portion 28 can meet the function requirement of rotating along the center thereof by connecting the first center connecting portion 287 with other toy brick units (such as forming a fingertip gyroscope), thereby enhancing the fun of the data line for the toy brick 100.

Referring to FIGS. 1-9, the first center connecting portion 287 is respectively electrical connection to each of the first branch connecting portion 281, the second branch connecting portion 282, the third branch connecting portion 283, the fourth branch connecting portion 284, the fifth branch connecting portion 285 and the sixth branch connecting portion 286. When no electrical connection is accessed to the first center connecting portion 287, the consumer needs to consider the possibility that the assembly structure of the toy brick with the multiple branch connecting portion 28 can't conduct electricity due to the non-conductive of the first center connecting portion 287, which limits the use of the multiple branch connecting portion 28. The first center connecting portion 287 is electrically connected to ensure that no matter user how to assembly, the combination toy brick after assembly is able to electrically connect to the first connection 30 and the second connection 40, to meet the use function of the data line for the toy brick 100 as the data line.

Referring to FIGS. 1-10, the connecting portion for the toy brick 20 further includes a U-shaped connecting portion 29. The U-shaped connecting portion 29 includes a first U-shaped connection end 291 and a second U-shaped connection end 292 electrically connected to the first U-shaped connection end 291. The U-shaped connecting portion 29 can increase the shape profile of the connecting portion for the toy brick 20, thereby further enhancing the enjoyment of the data line for the toy brick 100.

The connecting portion for the toy brick 20 includes a plurality of toy brick units (for easy to describe, the elements: the elbow connecting portion 23, the cross connecting portion 24, the T-shaped connecting portion 25, the linear connecting portion 26, the Y-shaped connecting portion 27, the multiple branch connecting portion 28 and the U-shaped connecting portion 29, collectively referred to as a toy brick unit), the plurality of toy brick units respectively includes at least two electrical connections (not shown), and the electrical connections in a single toy brick unit are electrically connected to each other. In this way, it can ensure that no matter the user how to combine, after assembly of the combination toy brick; any two connection ends respectively connected to the third connection end 32 and the fourth connection end 41 all can meet the requirement of electrical connection, and further meet the use demand of the data line for the toy brick 100 as the data line.

The various shapes of the connecting portion for the toy brick 20 assembled is for reference: Twelve elbow connections 23 can form the shape of a four-leaf clover or a snowflake, or form the shape of a mobile phone holder and a caterpillar, the closed loop can't be connected to the first connecting portion 30 and the second connecting portion 40. Eight elbow connecting portions 23 and one cross connecting portion 24 can form the shape of a square or a large windmill, or form the shape of a mobile phone holder and a business card holder. Four T-shaped connecting portions 25, three cross connecting portions 24, two linear connecting portions 26 and two elbow connecting portions 23 can form the shape of a faucet. Four cross connecting portions 24, eight elbow connecting portions 23 and eight linear connecting portions 26 can form the shape of a table or a chair. Four cross connecting portions 24 and eight elbow connecting portions 23 can form parallel bars or a boat or a seesaw, or form the shape of a mobile phone holder and a business card holder. Two cross connecting portions 24, three T-shaped connecting portions 25 and nine elbow connecting portions 23 can form the shape of a chair. Eight elbow connecting portions 23 and four linear connecting portions 26 can form the shape of a chain. Sixteen elbow connecting portions 23, seven cross connecting portions 24, five linear connecting portions 26 and two T-shaped connecting portions 25 can form the shape of a cannon or a machine gun. Nine elbow connecting portions 23, one cross connecting portion 24 and one linear connecting portion 26 can form the shape of a superman robot spider-man and a cannon and a crocodile and a lizard. One deformable adapter and one T-shaped connecting portion 25 can form the shape of a caring character. One cross connecting portion 24, four linear connecting portions 26 and four elbow connecting portions 23 can form the shape of a chair, a table, a receiving box and a mobile phone holder. Four elbow connecting portions 23, four cross connecting portions 24, two T-shaped connecting portions 25 and two linear connecting portions 26 can form the shape of a superman robot or form the shape of a small ornament receiving holder and a mobile phone holder. One T-shaped connecting portion 25, four cross connecting portions 24, one linear connecting portion 26 and four elbow connecting portions 23 can form the Chinese of “I”. Three T-shaped connecting portions 25, two cross connecting portions 24, three Y-shaped connecting portions 27 and ten linear connecting portions 26 can form the Chinese of “love”. Two T-shaped connecting portions 25, seven linear connecting portions 26, seven elbow connecting portions 23 and one cross connecting portion 24 can form the Chinese of “you”. Seven T-shaped connecting portions 25, thirteen linear connecting portions 26 and three elbow connecting portions 23 can form the English of LOVE. Sixteen linear connecting portions 26, thirteen elbow connecting portions 23, five cross connecting portions 24 and four T-shaped connecting portions 25 can form the shape of a super plane or a super machine gun. The above combination is a conventional assembly way, the fully assembled structure by users includes but not limited to the above combination.

It can be understood that the connecting portion for the toy brick 20 of the data line for the toy brick 100 is not limited to be used in data lines, but also can be used in other devices such as wired headphones to enhance the interest of the device.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A data line for a toy brick configured for signal transmission between a first device and a second device, the data line for the toy brick comprising:
a connecting portion for the toy brick, with a modular combination structure, comprising a first connection end a second connection end electrically connected to the first connection end;
a first connecting portion comprising a first device connection end and a fluid connection end electrically connected to the first device connection end;
a second connecting portion comprising a fourth connection end and a second device connection end electrically connected to the fourth connection end; wherein
the first device connection end is electrically connected to the first device, and the second device connection end is electrically connected to the second device; while the first connection end is electrically connected to the third connection end, and the second connection end is electrically connected to the fourth connection end; or, the third connection end is electrically connected to the fourth connection end, the connecting portion for the toy brick is as a kind of toy bricks.

2. The data line for the toy brick as claimed in claim 1, wherein the connecting portion for the toy brick comprises:
an elbow connecting portion comprising a first elbow connection end and a second elbow connection end electrically connected to the first elbow connection end, an angle formed at the connection between the first elbow connection end and the second elbow connection end;
a cross connecting portion comprising a first cross connection end, a second cross connection end, a third cross connection end and a fourth cross connection end; the first cross connection end electrically connected to each of the second cross connection end, the third cross connection end and the fourth cross connection end; the second cross connection end electrically connected to both the third cross connection end and the fourth cross connection end; the third cross connection end electrically connected to the fourth cross connection end; the first cross connection end and the third cross connection end being on a first line, and the second cross connection end and the fourth cross connection end being on a second line, with the first line perpendicular to the second line;
a T-shaped connecting portion comprising a first T-shaped connection end, a second T-shaped connection end and a third T-shaped connection end; the first T-shaped connection end electrically connected to both the second T-shaped connection end and the third T-shaped connection end, and the second T-shaped connection end electrically connected to the third T-shaped connection end; the first T-shaped connection end and the second T-shaped connection end being on a third line which is perpendicular to the third T-shaped connection end;
a linear connecting portion comprising a first linear connection end and a second linear connection end electrically connected to the first linear connection end;
the first elbow connection end electrically connected to the first cross connection end, the second cross connection end electrically connected to the first T-shaped connection end, the second T-shaped connection end electrically connected to the first linear connection end; and wherein two connection ends selected from the second elbow connection end, the third cross connection end, the fourth cross connection end, the third T-shaped connection end and the second linear connection end are respectively connected to the third connection end and the fourth connection end.

3. The data line for the toy brick as claimed in claim 2, wherein the connecting portion for the toy brick comprises four elbow connecting portions, two cross connecting portions, two T-shaped connecting portions and eight linear connecting portions.

4. The data line for the toy brick as claimed in claim 3, wherein the four elbow connecting portions, the two cross connecting portions, the two T-shaped connecting portions and the eight linear connecting portions are assembled and then simultaneously connected to the third connection end and the fourth connection end.

5. The data line for the toy brick as claimed in claim 2, wherein the connecting portion for the toy brick further comprises a Y-shaped connecting portion, the Y-shaped connecting portion comprising a first Y-shaped connection end, a second Y-shaped connection end and a third Y-shaped connection end; the first Y-shaped connection end electrically connected to both the second Y-shaped connection end and the third Y-shaped connection end, and the second Y-shaped connection end electrically connected to the third Y-shaped connection end; and wherein
the first Y-shaped connection end and/or the second Y-shaped connection end and/or the third Y-shaped connection end are connected to the second elbow connection end, and two connection ends selected from the third cross connection end, the fourth cross connection end, the third T-shaped connection end and the second linear connection end are respectively connected to the third connection and the fourth connection end.

6. The data line for the toy brick as claimed in claim 5, wherein the connecting portion for the toy brick comprises thirteen elbow connecting portions, seven cross connecting portions, seven T-shaped connecting portions, sixteen linear connecting portions and three Y-shaped connecting portions.

7. The data line for the toy brick as claimed in claim 2, wherein the connecting portion for the toy brick further comprises a multiple branch connecting portion, the multiple branch connecting portion comprising a first branch connecting portion, a second branch connecting portion, a third branch connecting portion, a fourth branch connecting portion, a fifth branch connecting portion and a sixth branch connecting portion; the first branch connecting portion, the second branch connecting portion, the third branch connecting portion, the fourth branch connecting portion, the fifth branch connecting portion and the sixth branch connecting portion are electrically connected to each other; the first branch connecting portion, and the fourth branch connecting portion being on a same line, the second branch connecting portion and the fifth branch connecting portion being on another same line, the third branch connecting portion and the sixth branch connecting portion being on a third same line.

8. The data line for the toy brick as claimed in claim 7, wherein the first branch connecting portion, the second branch connecting portion, the third branch connecting portion, the fourth branch connecting portion, the fifth branch connecting portion and the sixth branch connecting portion are evenly located along the center of a same plane, while a first center connecting portion is arranged on the center of the same plane and respectively electrical connection to each of the first branch connecting portion, the second branch connecting portion, the third branch connecting portion, the fourth branch connecting portion, the fifth branch connecting portion and the sixth branch connecting portion.

9. The data line for the toy brick as claimed in claim 7, wherein the connecting portion for the toy brick further comprises a U-shaped connecting portion, the U-shaped connecting portion comprising a first U-shaped connection end and a second U-shaped connection end electrically connected to the first U-shaped connection end.

10. The data line for the toy brick as claimed in claim 2, wherein the elbow connecting portion, the cross connecting portion, the T-shaped connecting portion and the linear connecting portion are arranged into plug connections, and the plug can be selected from a DC plug, an audio threaded plug, an audio un-threaded plug, a magnetic suction plug, a Micro 5 pin plug, a TYPE-C plug, a lighting plug and a USB plug.

11. A data line for a toy brick for signal transmission between a first device and a second device, the data line for the toy brick comprising:
a connecting portion for the toy brick, with a modular combination structure, comprising a first connection end and a second connection end electrically connected to the first connection end;
a first connecting portion comprising a first device connection end and a third connection end electrically connected to the first device connection end;
a second connecting portion comprising a fourth connection end and a second device connection end electrically connected to the fourth connection end;
a cross connecting portion;
an elbow connecting portion electrically connected to one end of the cross connecting portion;
a T-shaped connecting portion electrically connected to another end of the cross connecting portion;
a linear connecting portion electrically connected to another end of the T-shaped connecting portion; and wherein
the first device connection end is electrically connected to the first device, and the second device connection end is electrically connected to the second device; while the first connection end is electrically connected to the third connection end, and the second connection end is electrically connected to the fourth connection end; or, the third connection end is electrically connected to the fourth connection end; the connecting portion for the toy brick is as a kind of toy bricks.

12. The data line for the toy brick as claimed in claim 11, wherein the elbow connecting portion for the toy brick comprises a first elbow connection end and a second elbow connection end electrically connected to the first elbow connection end, an angle formed at the connection between the first elbow connection end and the second elbow connection end;
the cross connecting portion comprising a first cross connection end, a second cross connection end, a third cross connection end and a fourth cross connection end; the first cross connection end electrically connected to each of the second cross connection end, the third cross connection end and the fourth cross connection end; the second cross connection end electrically connected to both the third cross connection end and the fourth cross connection end; the third cross connection end electrically connected to the fourth cross connection end; the first cross connection end and the third cross connection end being on a first line, and the second cross connection end and the fourth cross connection end being on a second line, wife the first line perpendicular to the second line;
the T-shaped connecting portion comprising a first T-shaped connection end, a second T-shaped connection end and a third T-shaped connection end; the first T-shaped connection end electrically connected is both the second T-shaped connection end and the third T-shaped connection end, and the second T-shaped connection end electrically connected to the third T-shaped connection end; the first T-shaped connection end and the second T-shaped connection end being on a third line which is perpendicular to the third T-shaped connection end;
the linear connecting portion comprising a first linear connection end and a second linear connection end electrically connected to the first linear connection end;
the first elbow connection end electrically connected to the first cross connection end, the second cross connection electrically connected to the first T-shaped connection end, the second T-shaped connection end electrically connected to the first linear connection end; and wherein two connection ends selected from the second elbow connection end, the third cross connection end, the fourth cross connection end, the third T-shaped connection end and the second linear connection end are respectively connected to the third connection end and the fourth connection end.

13. The data line for the toy brick as claimed in claim 11, wherein the connecting portion for the toy brick comprises four elbow connecting portions, two cross connecting portions, two T-shaped connecting portions and eight linear connecting portions; the four elbow connecting portions, the two cross connecting portions, the two T-shaped connecting portions and the eight linear connecting portions are assembled and then simultaneously connected to the third connection end and the fourth connection end.

14. The data line for the toy brick as claimed in claim 11, wherein the elbow connecting portion, the cross connecting portion, the T-shaped connecting portion and the linear connecting portion are arranged into plug connections, and the plug can be selected from a DC plug, an audio threaded plug, an audio un-threaded plug, a magnetic suction plug, a Micro 5 pin plug, a TYPE-C plug, a Lighting plug and a USB plug.

15. The data line for the toy brick as claimed in claim 12, wherein the connecting portion for the toy brick further comprises a Y-shaped connecting portion, the Y-shaped connecting portion comprising a first Y-shaped connection end, a second Y-shaped connection end and a third Y-shaped connection end; the first Y-shaped connection end electrically connected to both the second Y-shaped connection end and the third Y-shaped connection end, and the second Y-shaped connection end electrically connected to the third Y-shaped connection end; and wherein
the first Y-shaped connection end and/or the second Y-shaped connection end and/or the third Y-shaped connection end are connected to the second elbow connection end, and two connection ends selected from the third cross connection end, the fourth cross connection end, the third T-shaped connection end and the second linear connection end are respectively connected to the third connection end and the fourth connection end.

16. The data line for the toy brick as claimed in claim 15, wherein the connecting portion for the toy brick comprises thirteen elbow connecting portions, seven cross connecting portions, seven T-shaped connecting portions, sixteen linear connecting portions and three Y-shaped connecting portions.

17. The data line for the toy brick as claimed in claim 12, wherein the connecting portion for the toy brick further comprises a multiple branch connecting portion, the multiple branch connecting portion comprising a first branch connecting portion, a second branch connecting portion, a third branch connecting portion, a fourth branch connecting portion, a fifth branch connecting portion and a sixth branch connecting portion; the first branch connecting portion, the second branch connecting portion, the third branch connecting portion, the fourth branch connecting portion, the fifth branch connecting portion and the sixth branch connecting portion electrically connected to each other; the first branch connecting portion and the fourth branch connecting portion being on a same line, the second branch connecting portion and the fifth branch connecting portion being on another same line, the third branch connecting portion and the sixth branch connecting portion being on a third same line; the first branch connecting portion, the second branch connecting portion, the third branch connecting portion, the fourth branch connecting portion, the fifth branch connecting portion and the sixth branch connecting portion are evenly located along the center of a same plane, while a first center connecting portion is arranged on the center of the same plane and respectively electrical connection to each of the first branch connecting portion, the second branch connecting portion, the third branch connecting portion, the fourth branch connecting portion, the fifth branch connecting portion and the sixth branch connecting portion.

18. The data line for the toy brick as claimed in claim 17, wherein the connecting portion for the toy brick further comprises a U-shaped connecting portion, the U-shaped connecting portion comprising a first U-shaped connection end and a second U-shaped connection end electrically connected to the first U-shaped connection end.
